(19) United States
(12) Patent Application Publication
(10) Pub. No.: US 2023/0156519 A1
(43) Pub. Date: May 18, 2023

(54) COMMUNICATION VOLUME CONTROL DEVICE, COMMUNICATION VOLUME CONTROL METHOD, ANDRECORDING MEDIUM WITH PROGRAM RECORDED THEREIN

(71) Applicant: NEC Corporation, Minato-ku, Tokyo (JP)

(72) Inventors: Nana JUMONJI, Tokyo (JP); Naohiro KOUSAKA, Tokyo (JP); Maiko HASEGAWA, Tokyo (JP); Masaya TOKUNAGA, Tokyo (JP)

(73) Assignee: NEC Corporation, Minato-ku, Tokyo (JP)

(21) Appl. No.: 17/910,435

(22) PCT Filed: Mar. 31, 2020
(86) PCT No.: PCT/JP2020/014876

§ 371 Date: Sep. 9, 2022

(51) Int. Cl. H04W 28/02

(52) U.S. Cl. CPC H04W 28/0289; H04W 28/0226

(57) ABSTRACT

A communication volume control device according to an aspect of the present disclosure includes: at least one memory configured to store instructions; and at least one processor configured to execute the instructions to: acquire, when a disaster occurs, target area information indicating a target area expected to be impacted by the disaster that has occurred; and instruct a plurality of imaging devices, which are mounted to each of a plurality of moving bodies and which transmit monitoring information related to captured images to a monitoring device at a predetermined timing, to adjust a communication volume based on the target area information when transmitting the monitoring information to the monitoring device from the imaging devices.

### TECHNICAL FIELD

The present disclosure relates to a communication volume control device, a communication volume control method, and a program.

### BACKGROUND ART

A system that collects road images captured by a vehicle and monitors a road status is known.

For example, PTL 1 discloses a technique in which a plurality of vehicles mounted with drive recorders are caused to travel, and road images to be captured by each vehicle and information on image capturing such as a time, a position, and the like are transmitted as image information to an analysis device via a communication network. The data analysis device uses the received image information to analyze a road status. The technique of PTL 1 may be used by a road manager of a disaster-stricken area to grasp road conditions allowing travel through the disaster-stricken area for evacuation and safe movement of residents in the disaster-stricken area during a disaster.

During a disaster, a communication band in the disaster-stricken area may become overwhelmed due to an increase in communication caused by safety confirmation and information collection not only by disaster victims, but also by people outside the disaster-stricken area, or further, caused by a power outage, a disaster at a base station, or the like. When the communication band is in such an overwhelmed state, it is difficult for an information processing device to receive image information, including images from vehicles.

In response, PTL 2 discloses a technique for reducing a communication volume (information volume) by only transmitting image information showing unusual behavior, for example, sharp turning, repeated braking, a sudden decrease in speed, or the like from vehicles to a data analysis device.

### CITATION LIST

### Patent Literature

[PTL 1] WO 2015/129045 A
[PTL 2] JP 2019-160199 A

### SUMMARY OF INVENTION

### Technical Problem

However, in the technique of PTL 2, there is a possibility that information necessary for responding during a disaster may be insufficient, or a large amount of image information not related to damage conditions of a disaster-stricken area may be transmitted. Therefore, with the technique of PTL 2, an operator of the information processing device cannot quickly acquire the information necessary for responding during the disaster in the disaster-stricken area.

An object of the present disclosure is to provide a communication volume control device, a communication volume control method, and a program capable of solving the above-described problems by suppressing the occurrence of data communication congestion when a disaster occurs and allowing the acquisition of information necessary for responding to a disaster in a disaster-stricken area.

### Solution to Problem

A communication volume control device according to one aspect of the present disclosure, includes: an acquisition means configured to acquire, when a disaster occurs, target area information indicating a target area expected to be impacted by the disaster that has occurred; and an instruction means configured to instruct a plurality of imaging devices, which are mounted to each of a plurality of moving bodies and which transmit monitoring information related to captured images to a monitoring device at a predetermined timing, to adjust a communication volume based on the target area information when transmitting the monitoring information to the monitoring device from the imaging devices.

A communication volume control method according to one aspect of the present disclosure includes: acquiring, when a disaster occurs, target area information indicating a target area expected to be impacted by the disaster that has occurred; and instructing a plurality of imaging devices, which are mounted to each of a plurality of moving bodies and which transmit monitoring information related to captured images to a monitoring device at a predetermined timing, to adjust a communication volume based on the target area information when transmitting the monitoring information to the monitoring device from the imaging devices.

A recording medium according to one aspect of the present disclosure records a program caused to execute a process including: acquiring, when a disaster occurs, target area information indicating a target area expected to be impacted by the disaster that has occurred; and instructing a plurality of imaging devices, which are mounted to each of a plurality of moving bodies and which transmit monitoring information related to captured images to a monitoring device at a predetermined timing, to adjust a communication volume based on the target area information when transmitting the monitoring information to the monitoring device from the imaging devices.

### Advantageous Effects of Invention

An effect of the present disclosure is to suppress the occurrence of data communication congestion when a disaster occurs and allow the acquisition of information necessary for responding to a disaster in a disaster-stricken area.

### BRIEF DESCRIPTION OF DRAWINGS

FIG. 1 is a schematic diagram illustrating an outline of a monitoring system 10 according to a first example embodiment.

FIG. 2 is a block diagram illustrating an example of a configuration of the monitoring system 10 according to the first example embodiment.

FIG. 3 is an example of a table illustrating a relationship between a disaster classification and a hazard map according to the first example embodiment.

FIG. 4 is an example of a hazard map indicating an area in which a mudslide is expected, according to the first example embodiment.

FIG. 5 is an example of a hazard map indicating an area in which flooding damage caused by an overflowing river is expected, according to the first example embodiment.

FIG. 6 is an example of a hazard map indicating an area in which damage caused by a volcanic eruption is expected, according to the first example embodiment.

FIG. 7 is an example of a hazard map indicating an area in which damage caused by a tsunami is expected, according to the first example embodiment.

FIG. 8 is a flowchart illustrating a communication volume reduction process according to the first example embodiment.

FIG. 9 is an example of a map showing a target area according to the first example embodiment.

FIG. 10 is a block diagram illustrating an example of another configuration of the monitoring system 10 according to the first example embodiment.

FIG. 11 is an example of disaster information when the disaster classification is an earthquake, according to a second example embodiment.

FIG. 12 is an example of disaster information when the disaster classification is a tsunami, according to the second example embodiment.

FIG. 13 is an example of disaster information when the disaster classification is typhoon/heavy rain, according to the second example embodiment.

FIG. 14 is an example of disaster information when the disaster classification is an eruption, according to the second example embodiment.

FIG. 15 is a flowchart of a communication volume reduction process according to the second example embodiment.

FIG. 16 is a block diagram illustrating an example of a configuration of a communication volume control device 1 according to a third example embodiment.

FIG. 17 is a block diagram illustrating an example of a hardware configuration of a computer 500.

### EXAMPLE EMBODIMENT

The example embodiments will be described in detail with reference to the drawings. The same reference numerals are given to the same constituent elements in each of the drawings and each of the example embodiments described in the description, and descriptions thereof will be omitted as appropriate.

### First Example Embodiment

A first example embodiment will be described. The present example embodiment will be described on the assumption that imaging devices are mounted to vehicles, which are a type of moving body.

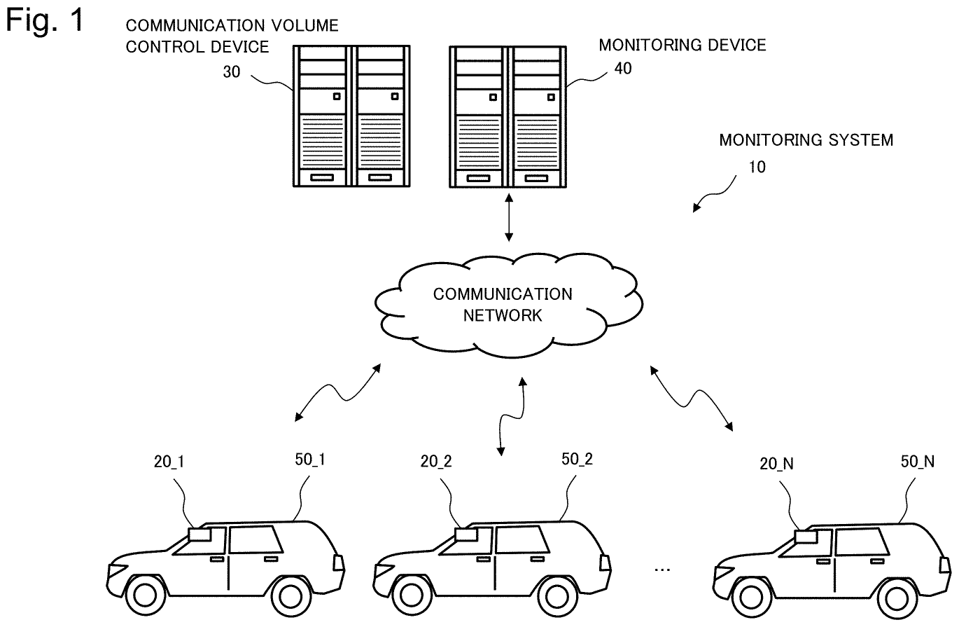

First, a configuration of a monitoring system according to the first example embodiment will be described. FIG. 1 is a schematic diagram illustrating an outline of a monitoring system 10 according to the first example embodiment. In reference to FIG. 1, the monitoring system 10 includes a plurality of imaging devices 20_1, 20_2, . . . 20_N (N represents a natural number) (hereinafter also collectively referred to as imaging devices 20), a communication volume control device 30, a monitoring device 40, and a plurality of vehicles 50_1, 50_2, . . . 50_N (N represents a natural number) (hereinafter also collectively referred to as vehicles 50).

In the monitoring system 10, the imaging devices 20_1, 20_2, . . . 20_N are mounted to each of the vehicles 50_1, 50_2, . . . 50_N belonging to an institution that manages roads, for example, a local government body, a road management company, or the like. In the monitoring system 10, the communication volume control device 30, the monitoring device 40, and the imaging devices 20_1, 20_2, . . . 20_N are connected in such a way as to be communicable, for example, via a communication network.

The communication volume control device 30 and the monitoring device 40 are arranged, for example, at a road management department of the above-described institution. The communication volume control device 30 and the monitoring device 40 may be arranged at a place other than the road management department of the above-described institution. In this case, the communication volume control device 30 and the monitoring device 40 may be enabled by a cloud computing system.

A case in which the imaging devices 20 are mounted to the vehicles 50 in the present example embodiment will be described. In this case, the imaging devices 20 may be, for example, drive recorders mounted to a vehicle. The imaging devices 20 may be mounted to another moving body such as a bicycle, a drone, or the like, or a person may carry the imaging devices 20 while walking. An image capturing device is not limited to the moving bodies, but may be a fixed/fixed point camera installed on a traffic light or the like.

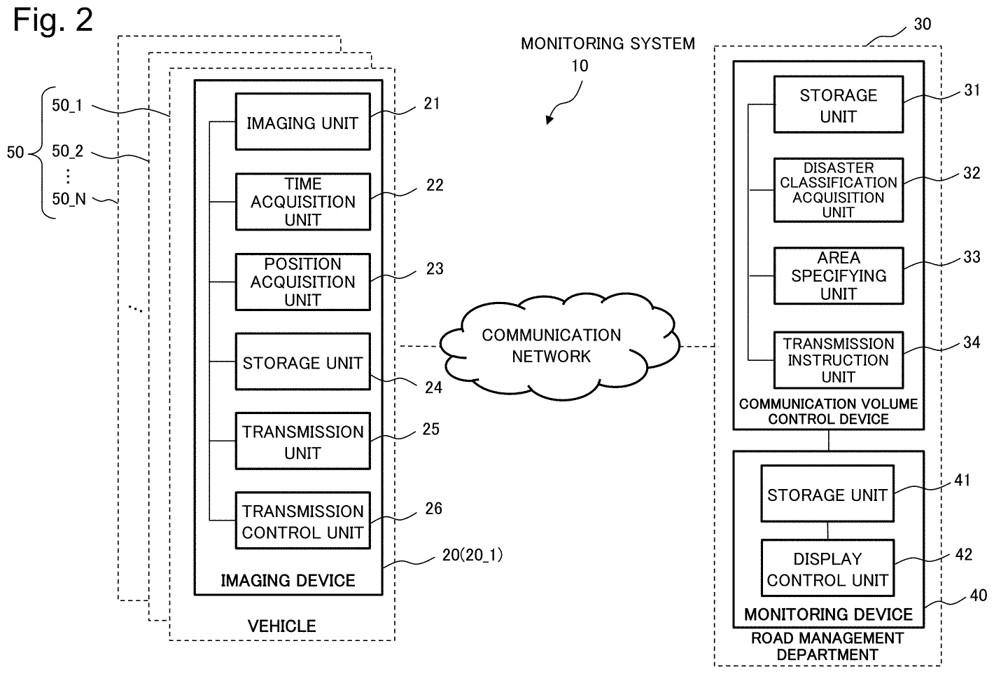

Next, a configuration of each device will be described with reference to FIG. 2. FIG. 2 is a block diagram illustrating an example of a configuration of the monitoring system 10 according to the first example embodiment.

(Configuration of Imaging Devices)

As illustrated in FIG. 2, the imaging devices 20 include an imaging unit 21, a time acquisition unit 22, a position acquisition unit 23, a storage unit 24, a transmission unit 25, and a transmission control unit 26.

The imaging unit 21 captures a periphery of the vehicles 50. The imaging unit 21 captures a periphery of the vehicles 50 at predetermined intervals while the vehicles 50 travel on a road. The images obtained by image capturing may or may not include images of peripheral roads, such as forward of the vehicles 50 and the like. The images obtained by image capturing are images of a periphery of moving bodies when the imaging devices 20 are mounted to all of the moving bodies, and the images are of a periphery of a person when the imaging devices 20 are carried by the person.

The time acquisition unit 22 acquires a time of image capturing by the imaging unit 21 (hereinafter also referred to as an image capturing time). For example, the time acquisition unit 22 may acquire the image capturing time from the time (system clock) managed by the imaging devices 20 in conjunction with the image capturing of the imaging unit 21. The time acquisition unit 22 outputs the image capturing time to the imaging unit 21.

The position acquisition unit 23 acquires a position captured by the imaging unit 21 (hereinafter also referred to as an image capturing position). For example, the position acquisition unit 23 may be configured in such a way as to acquire the image capturing position in conjunction with the imaging capturing of the imaging unit 21. The position acquisition unit 23 outputs, for example, the image capturing position to the imaging unit 21. The position acquisition unit 23 is, for example, a global positioning system (GPS) receiver, and may be included in the imaging unit 21, or may be a separate unit.

The imaging unit 21 acquires the image capturing time from the time acquisition unit 22, acquires the image capturing position from the position acquisition unit 23, and stores the captured images in the storage unit 24 as the monitoring information in association with the image capturing time and the image capturing position.

The storage unit 24 stores vehicle identifiers (IDs). The storage unit 24 also stores the monitoring information. The storage unit 24 is, for example, a random access memory (RAM).

The transmission unit 25 acquires the monitoring information from the storage unit 24 and transmits it to the monitoring device 40 via a communication network. The monitoring information may be transmitted, for example, in a mode in which the monitoring information including the images is transmitted each time an image is captured, or in a mode in which the monitoring information including each of one or more images captured in each period is transmitted at each predetermined period. A communication volume of the monitoring information transmitted by the transmission unit 25 is controlled by the transmission control unit 26.

The transmission control unit 26 controls the communication volume of the monitoring information transmitted from the transmission unit 25. When the transmission control unit 26 receives an instruction from the later-described communication volume control device 30 to reduce the communication volume of the monitoring information to be transmitted (hereinafter also referred to as a communication volume reduction instruction), it reduces the communication volume of the monitoring information to less than a normal state (before a disaster has occurred). For example, during a normal state, the transmission control unit 26 causes the transmission unit 25 to transmit the above-described monitoring information including the vehicle IDs, the images, the image capturing time, and the image capturing position as is. When the communication volume is reduced, the transmission control unit 26 causes the transmission unit 25 to transmit the above-described monitoring information excluding the images. The transmission control unit 26 may also change a frame rate or a bit rate of the images to reduce the communication volume instead of excluding the images from the monitoring information to reduce the communication volume.

(Configuration of Communication Volume Control Device)

The communication volume control device 30 includes a storage unit 31, a disaster classification acquisition unit 32, an area specifying unit 33, and a transmission instruction unit 34. The area specifying unit 33 is an example embodiment of an acquisition unit in the present disclosure. The transmission instruction unit 34 is an example embodiment of an instruction unit in the present disclosure. Some or all of the constituent elements of the communication volume control device 30 may be enabled by a cloud computing system, as described above. For example, the storage unit 31, the area specifying unit 33, and the transmission instruction unit 34 may be arranged on a cloud, and the disaster classification acquisition unit 32 may be arranged at a road management department.

The storage unit 31 stores a classification of the disaster that has occurred acquired by the disaster classification acquisition unit 32. Examples of the disaster classification include earthquake, tsunami, typhoon/heavy rain, and eruption.

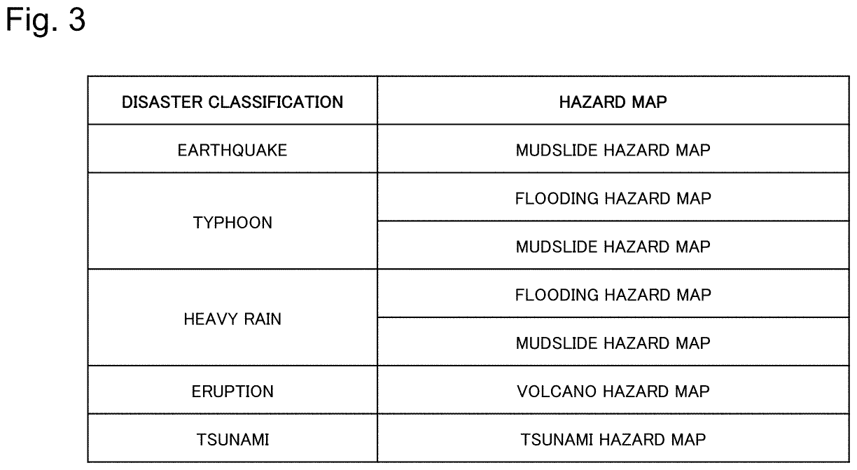

The storage unit 31 is loaded in advance with hazard maps of predetermined areas based on the disaster classification. FIG. 3 is an example of a table illustrating a relationship between a disaster classification and a hazard map according to the first example embodiment. In reference to FIG. 3, it is illustrated that, for example, a mudslide hazard map is used when the disaster classification is earthquake. Details of the hazard maps will be described later.

The disaster classification acquisition unit 32 acquires the classification of the disaster that has occurred from, for example, an external source such as a meteorological agency or the like. The disaster classification acquisition unit 32 may acquire the classification of the disaster that has occurred from an input by an operator or the like via an input device (not illustrated). The disaster classification acquisition unit 32 causes the storage unit 31 to store the acquired disaster classification.

The area specifying unit 33 acquires the classification of the disaster that has occurred from the storage unit 31. The area specifying unit 33 acquires the hazard map from the storage unit 31 based on the acquired disaster classification and the table illustrating a relationship between a disaster classification and a hazard map. The area specifying unit 33 specifies an area in which damage caused by the disaster is expected, that is, an area to which the monitoring information should be transmitted as a priority (hereinafter also referred to as a target area), from the acquired hazard map. The area specifying unit 33 outputs information on a target area to the transmission instruction unit 34. The area specifying unit 33 may acquire the hazard map from an external database or a website of a public institution (such as a meteorological agency, a prefectural government, or the like) via a communication network.

The transmission instruction unit 34 transmits the communication volume reduction instruction to the vehicles 50 located outside the target area based on the information on the target area output from the area specifying unit 33. The communication volume reduction instruction is an instruction to reduce the communication volume of the monitoring information to less than before the disaster (a normal state).

The transmission instruction unit 34 transmits, for example, the communication volume reduction instruction to all of the communicable vehicles 50 by specifying the target area. In this case, the imaging devices 20 of each vehicle 50 determine whether the vehicles 50 are located outside the target area, and reduce the communication volume when they are located outside the target area.

The transmission instruction unit 34 may extract the vehicles 50 located outside the target area based on the monitoring information, and transmit the communication volume reduction instruction to the vehicles 50. The vehicles 50 located outside the target area are extracted based on the image capturing position included in, for example, the monitoring information stored in a storage unit 41 of the monitoring device 40.

(Configuration of Monitoring Device)

The monitoring device 40 includes the storage unit 41 and a display control unit 42.

The storage unit 41 stores the monitoring information received from the imaging devices 20.

The display control unit 42 acquires, for example, the monitoring information of a position specified by an operator from the storage unit 41 and causes a display device (not illustrated) to display the images included in the monitoring information. The display control unit 42 may acquire the monitoring information from the storage unit 41 and display a mark indicating the presence of the monitoring information from the vehicles 50 at a location associated with the image capturing positions included in the monitoring information on the hazard map, and it may also cause the display device (not illustrated) to display the mark.

Next, the hazard maps based on the disaster classifications will be described.

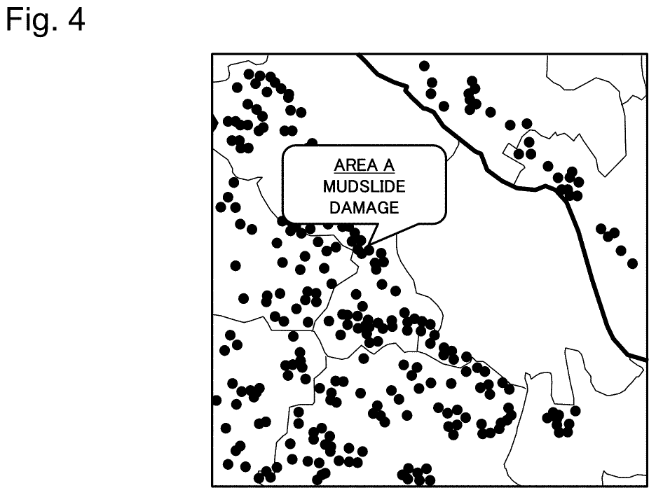

FIG. 4 is an example of a hazard map indicating an area in which a mudslide is expected, according to the first example embodiment. Mudslides occur after heavy rain or an earthquake. Therefore, a hazard map such as is illustrated in FIG. 4 is used when the disaster classification is typhoon/heavy rain or earthquake. In reference to FIG. 4, in the case of a mudslide, an area (position) indicated by a black dot such as is illustrated in an area A indicates that a mudslide is likely to occur.

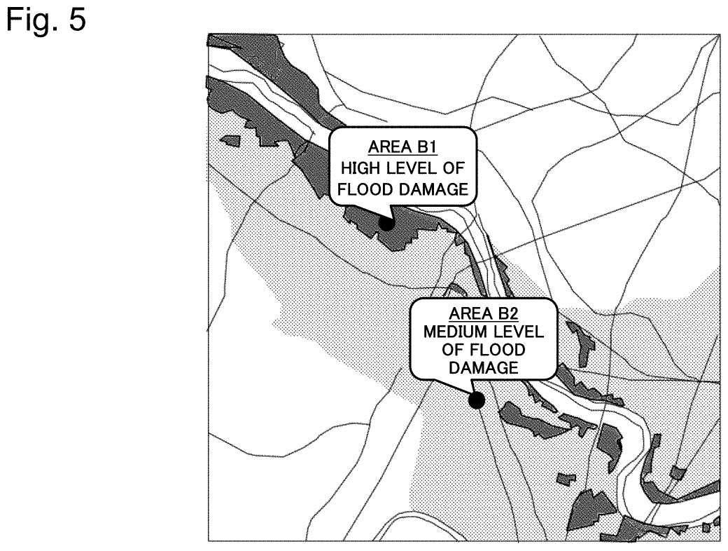

FIG. 5 is an example of a hazard map indicating an area in which flooding damage caused by an overflowing river is expected, according to the first example embodiment. A hazard map such as is illustrated in FIG. 5 is used when the disaster classification is typhoon/heavy rain. In reference to FIG. 5, in the case of an overflowing river, an area with heavy shading such as is shown in an area B1 indicates that an amount of flooding damage is greater than that in an area with light shading, such as is shown in an area B2.

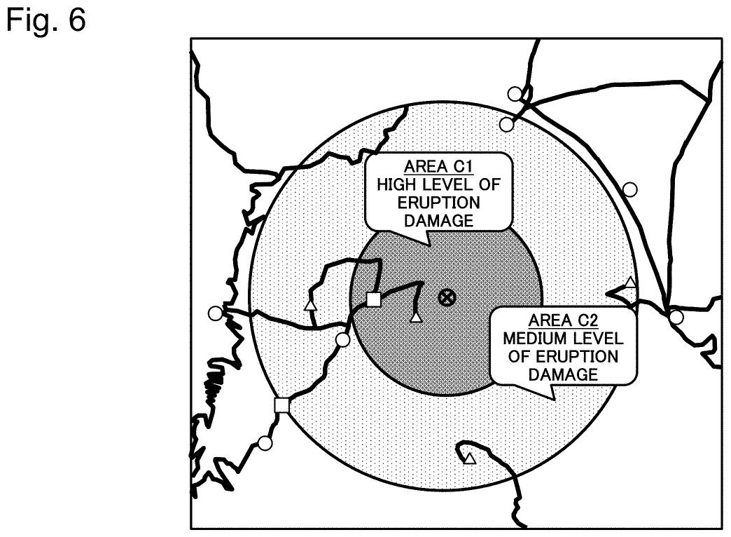

FIG. 6 is an example of a hazard map indicating an area in which damage caused by a volcanic eruption is expected, according to the first example embodiment. A hazard map such as is illustrated in FIG. 6 is used when the disaster classification is eruption. In reference to FIG. 6, in the case of a volcanic eruption, an area with heavy shading such as is shown in an area C1 indicates that an amount of damage caused by the eruption is greater than that in an area with light shading, such as is shown in an area C2.

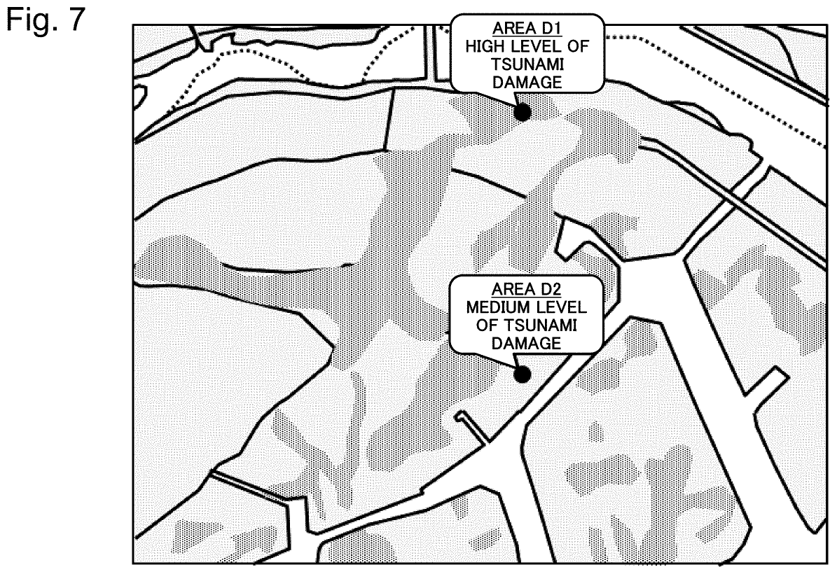

FIG. 7 is an example of a hazard map indicating an area in which damage caused by a tsunami is expected, according to the first example embodiment. A hazard map such as is illustrated in FIG. 7 is used when the disaster classification is tsunami. In reference to FIG. 7, in the case of a tsunami, an area with heavy shading such as is shown in an area D1 indicates that an amount of damage caused by the tsunami is greater than that in a lightly shaded area, such as is illustrated in an area D2.

As illustrated above, depending on the disaster classification, a hazard map in which areas are split into levels based on a magnitude of the expected damage is created. It is possible to use these hazard maps with the approval of hazard map creators, such as a local government body or the like.

Next, operation of the first example embodiment will be described.

(Communication Volume Reduction Process)

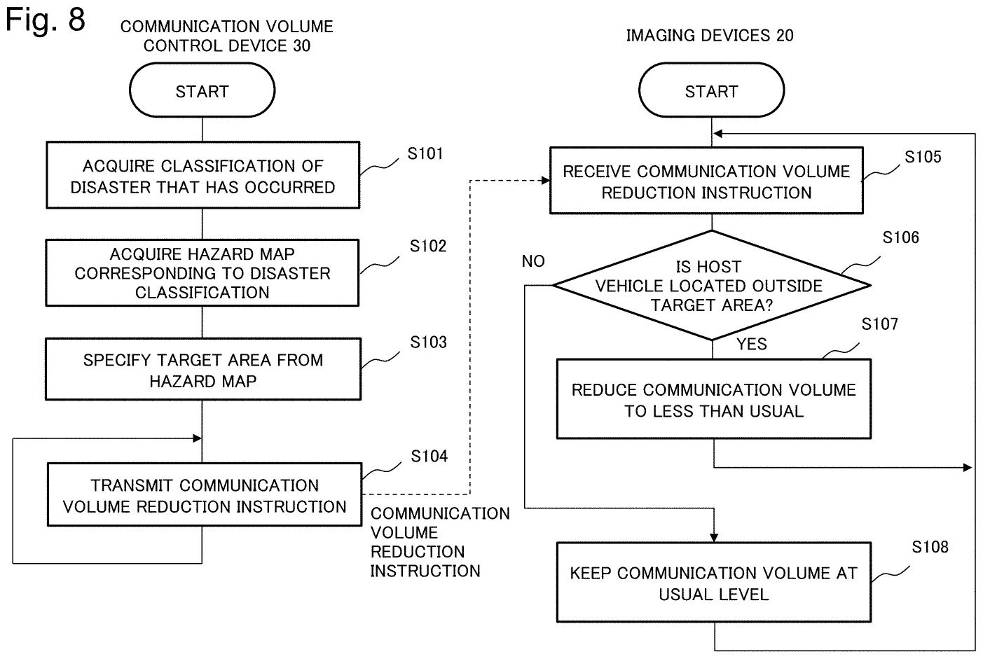

A communication volume reduction process of the monitoring system 10 will be described with reference to FIGS. 8 to 12.

FIG. 8 is a flowchart illustrating a communication volume reduction process according to the first example embodiment. The communication volume reduction process may be executed, for example, automatically when a disaster occurs, or it may be executed based on an instruction from an operator or the like. The following process of step S101 to step S104 is a process performed in the communication volume control device 30. The following process of step S105 to step S108 is a process performed in the imaging devices 20 of the vehicles 50.

The disaster classification acquisition unit 32 of the communication volume control device 30 acquires the classification of the disaster that has occurred from an external website of a meteorological agency or the like and stores it in the storage unit 31 (step S101). The disaster classification acquisition unit 32 acquires, for example, heavy rain as the classification of the disaster that has occurred from the meteorological agency.

The area specifying unit 33 acquires a hazard map based on the disaster classification in reference to the classification of the disaster that has occurred stored in the storage unit 31. (Step S102). For example, when the classification of the disaster that has occurred is heavy rain, the area specifying unit 33 acquires the mudslide hazard map (see FIG. 4) and a flooding hazard map (see FIG. 5) based on the table showing a relationship between a disaster classification and a hazard map split by disaster (see FIG. 3).

The area specifying unit 33 specifies an area in which damage is expected indicated in the acquired hazard map as the target area (step S103). For example, in reference to the flooding hazard map of FIG. 5, the area specifying unit 33 sets the area with heavy shading (an area in which an expected level of flooding damage is high) such as is illustrated in the area B1 and the area with light shading (an area in which an expected level of flooding damage is medium) such as is illustrated in the area B2 as the target area.

The transmission instruction unit 34 transmits the communication volume reduction instruction to the vehicles 50 located outside the target area (step S104). The transmission instruction unit 34 transmits the communication volume reduction instruction to all of the communicable vehicles 50 by specifying the target area. For example, the transmission instruction unit 34 transmits the communication volume reduction instruction specifying the area B1 and the area B2 as the target area.

When the transmission control unit 26 in the imaging devices 20 of the each vehicle 50 receives the communication volume reduction instruction from the transmission instruction unit 34 of the communication volume control device 30 (step S105), the vehicles 50 determine whether a host vehicle is located outside the target area (step S106). The transmission control unit 26 determines whether the host vehicle is located outside the target area based on, for example, map information stored in advance in the storage unit 24 or the like and the position of the host vehicle acquired by the position acquisition unit 23.

When the host vehicle is located outside the target area (step S106/Yes), the transmission control unit 26 reduces the communication volume to less than a normal state when transmitting the monitoring information (step S107). When the host vehicle is located in the target area (step S106/No), the transmission control unit 26 keeps the communication volume to that of a normal state when transmitting the monitoring information (step S108).

For example, the vehicles 50 located outside the area B1 and the area B2 transmit the monitoring information excluding the images to the monitoring device 40. The vehicles 50 located in the area B1 and the area B2 transmit the monitoring information including the images to the monitoring device 40.

Thereafter, the process from step S104 is repeatedly executed at a predetermined time interval in the communication volume control device 30. The process in step S105 to step S108 is repeatedly executed in the imaging devices 20 of the each vehicle 50 each time the communication volume reduction instruction is received.

Through this, from the time a disaster occurs, for the target area, the monitoring information including the images is stored, and for the areas other than the target area, the monitoring information not including the images is stored in the storage unit 41.

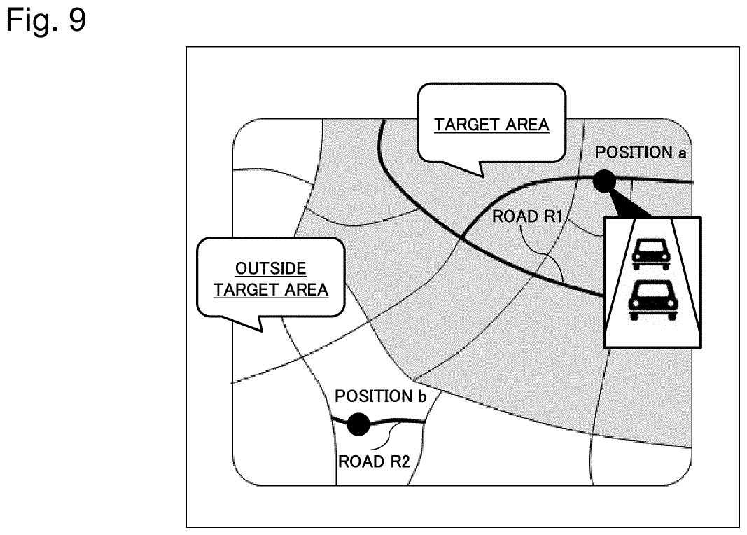

A display example displayed on the display device by the display control unit 42 will be described with reference to FIG. 9. FIG. 9 is an example of a map showing the target area according to the first example embodiment. In the example of FIG. 9, the target area in an area that is a current position is shown using shading, and an area outside the target area is shown with a blank background. On the map of FIG. 9, a road through which the vehicles 50 have passed after the disaster occurs are indicated by a thick line. In reference to FIG. 9, a road R1 through which the vehicles 50 have passed in the target area and a road R2 through which the vehicles 50 have passed outside the target area are illustrated. The vehicles 50 passing at each position on the roads is detected by receiving the monitoring information including the positions.

When an operator of the monitoring device 40 references images of a position a in the target area, for example, the display control unit 42 acquires the images of the position a stored in the storage unit 31 of the communication volume control device 30 to display on the display device in response to the operator clicking on the position a. In the example of FIG. 9, images of peripheral roads of the vehicles 50 located at the position a are displayed as the images of the position a.

When the operator of the monitoring device 40 references images of a position b outside the target area, outside the target area, no images are transmitted from the vehicles 50 and no images are present in the monitoring device 40 after the disaster occurs. Therefore, when the operator references the images of the position b outside the target area, for example, based on the monitoring information related to the position b (vehicle ID, position, and time), the display control unit 42 may request the vehicles 50 having the vehicle ID to transmit the images at the position b to the monitoring device 40 in response to the operator clicking on the position b. The display control unit 42 may also display the images at the position b transmitted from the vehicles 50 on the map.

The operation of the first example embodiment is thereby completed.

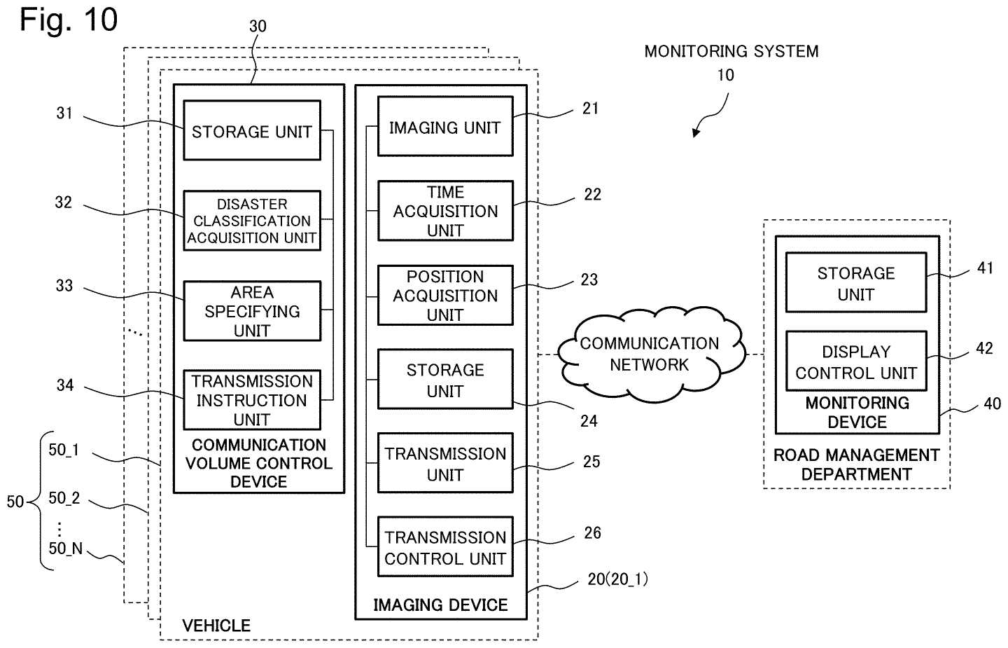

In the first example embodiment, the communication volume control device 30 and the monitoring device 40 have been configured to be arranged at a road management department, however as illustrated in FIG. 10, the communication volume control device 30 and the imaging devices 20 may be mounted to the vehicles 50.

The communication volume control device 30 and the monitoring device 40 may be included in one device, or the communication volume control device 30 and the imaging devices 20 may be included in one device.

In the first example embodiment, the area specifying unit 33 specified the area in which damage was expected indicated in the acquired hazard map as the target area. The area specifying unit 33 is not limited hereto but may specify an area in which an expected level of damage is equal to or more than a predetermined value as the target area from among the areas in which damage is expected, and the transmission instruction unit 34 may transmit the communication volume reduction instruction to the vehicles 50 located outside the target area. The transmission instruction unit 34 may transmit a communication volume reduction instruction to the vehicles 50 to change a reduction amount of the communication volume based on the expected level of damage (a degree of impact of a disaster) in the target area. In this case, the transmission instruction unit 34 decreases, for example, the reduction amount of the communication volume the higher the expected level of damage.

In the first example embodiment, the monitoring information has been configured to include images, however it is not limited hereto. In respect of the monitoring information, the communication volume from the vehicles 50 outside the target area may be reduced in the target area and outside the target area, and images may be excluded.

Next, an effect of the first example embodiment will be described.

According to the first example embodiment, the occurrence of data communication congestion when a disaster occurs is suppressed and information necessary for responding to a disaster in a disaster-stricken area can be acquired. The reason is due to the following. The area specifying unit 33 of the communication volume control device 30 acquires the hazard map indicating the area in which the damage of the disaster that has occurred is expected. This is because the transmission instruction unit 34 instructs the imaging devices of the vehicles outside the target area to reduce the communication volume when transmitting the monitoring information to the monitoring device from the imaging devices to less than before the disaster occurred, with the area in which the damage of the disaster is expected set as the target area based on the acquired hazard map.

### Second Example Embodiment

A second example embodiment will be described.

The second example embodiment differs from the first example embodiment in that it uses disaster information including a degree (level) of disaster for each area based on the disaster classification, instead of the hazard map.

The configuration of the monitoring system in the second example embodiment is the same as the configuration of the monitoring system 10 according to the first example embodiment (FIG. 2). However, in the second example embodiment, the actions of the storage unit 31, the disaster classification acquisition unit 32, and the area specifying unit 33 are different. For the second example embodiment, only the parts differing from those of the first example embodiment will be described, with reference to FIG. 2.

The storage unit 31 stores the monitoring information received from the imaging devices 20. The storage unit 31 stores the disaster information acquired by the disaster classification acquisition unit 32. The disaster information includes the degree (level) of disaster and the areas based on the disaster classifications.

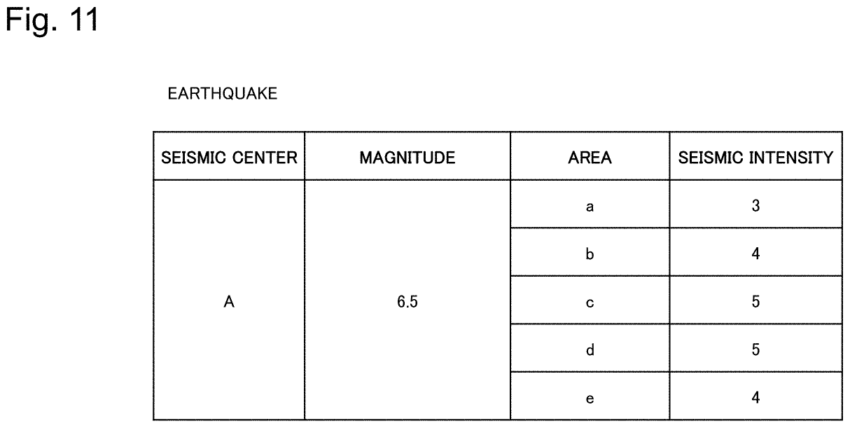

The disaster information will be described with reference to FIGS. 11 to 14. FIG. 11 is an example of disaster information when the disaster classification is earthquake, according to the second example embodiment. In reference to FIG. 11, the disaster information related to an earthquake may include, for example, an area A that is a seismic source, a magnitude, and a seismic intensity of each area a to e as the degree (level) of disaster.

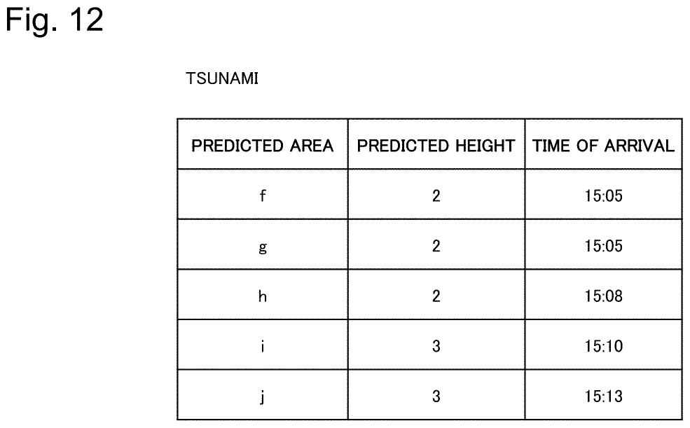

FIG. 12 is an example of disaster information when the disaster classification is tsunami, according to the second example embodiment. In reference to FIG. 12, the disaster information related to a tsunami may include, for example, forecast areas f to j in which tsunami damage is expected and a wave height in each of the forecast areas as the degree (level) of disaster.

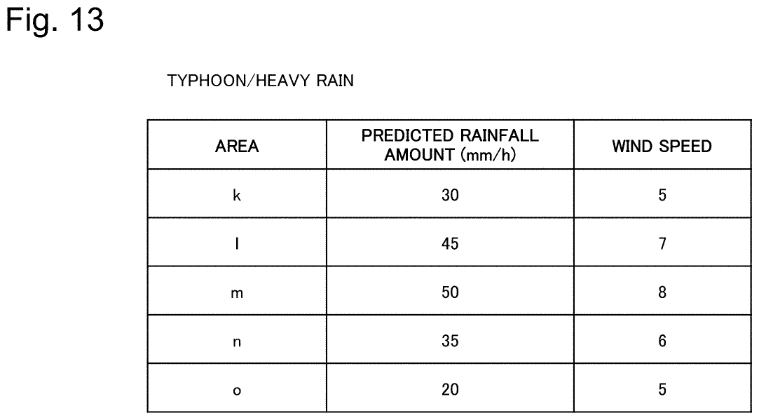

FIG. 13 is an example of disaster information when the disaster classification is typhoon/heavy rain, according to the second example embodiment. In reference to FIG. 13, the disaster information related to a typhoon/heavy rain may include, for example, areas k to o in which damage is expected, in addition to an expected rainfall amount and a wind speed in each of the areas as the degree (level) of disaster.

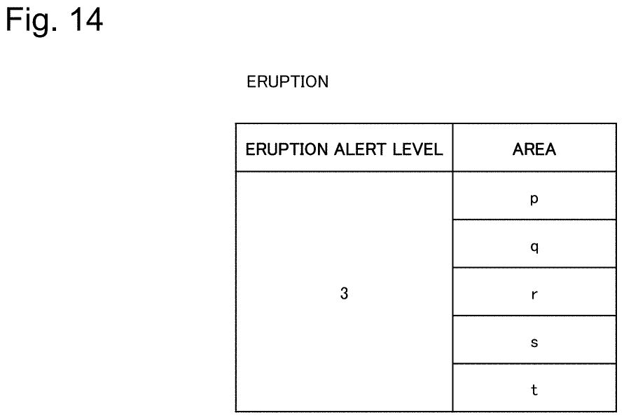

FIG. 14 is an example of disaster information when the disaster classification is eruption, according to the second example embodiment. In reference to FIG. 14, the disaster information related to an eruption may include, for example, an eruption alert level as the degree (level) of disaster and target areas to be alerted.

These types of disaster information are illustrative examples according to the present example embodiment and are not limited to the above-described examples. For example, the disaster information related to a typhoon/heavy rain may further include areas in which damage caused by an overflowing river is expected.

The disaster classification acquisition unit 32 acquires the disaster information on a disaster that has occurred from, for example, an external source such as a meteorological agency or the like. Since there are cases where the disaster information is updated as needed, the disaster classification acquisition unit 32 may acquire the disaster information periodically.

The area specifying unit 33 acquires disaster information in which the degree (level) of disaster is equal to or more than a predetermined threshold value from the storage unit 31. The disaster information in which the degree (level) of disaster is equal to or more than the predetermined threshold is disaster information including areas in which the degree (level) of disaster is equal to or more than the threshold. For example, when the disaster information is earthquake, it includes areas in which shaking at a seismic intensity equal to or more than 5 has been observed. The area specifying unit 33 does not acquire the disaster information when there is no disaster information in which the degree (level) of disaster is equal to or more than the predetermined threshold in the storage unit 31.

The area specifying unit 33 specifies an area included in the acquired disaster information as a target area.

Next, operation of the second example embodiment will be described.

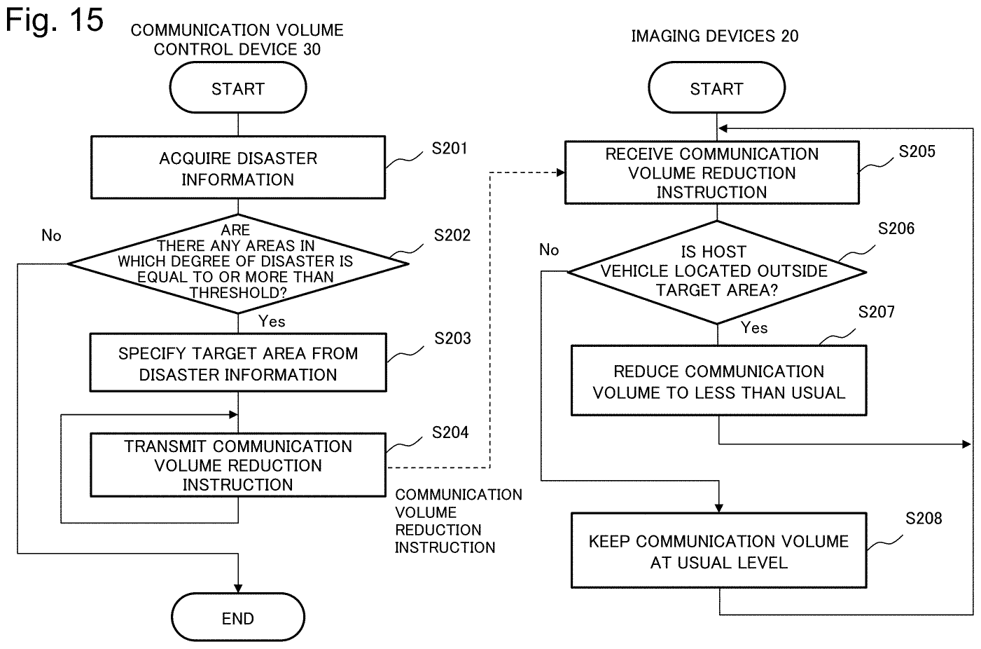

A communication volume reduction process in the monitoring system according to the second example embodiment will be described. FIG. 15 is a diagram illustrating a flowchart of the communication volume reduction process according to the second example embodiment.

The disaster classification acquisition unit 32 acquires the disaster information from an external site such as a meteorological agency or the like and stores it in the storage unit 31 (step S201). The area specifying unit 33 references the disaster information stored in the storage unit 31 and determines whether there are any areas in which the degree (level) of disaster is equal to or more than the threshold (step S202). In a case where there is an area in which the degree (level) of disaster is equal to or more than the threshold (step S202/Yes), the area specifying unit 33 specifies the area as the target area (step S203). In the case where the disaster information is earthquake (see FIG. 11) and the threshold is set to a seismic intensity of 5, the area specifying unit 33 specifies the area c and the area d as the target area.

Thereafter, the process from step S204 is repeatedly executed at a predetermined time interval in the communication volume control device 30. The process in step S205 to step S208 is repeatedly executed in the imaging devices 20 of the each vehicle 50 each time the communication volume reduction instruction is received.

When there are no areas in which the degree (level) of disaster is equal to or more than the threshold (step S202/No), the area specifying unit 33 ends the communication volume reduction process.

The operation of the second example embodiment is thereby completed.

In the second example embodiment, the disaster information based on the disaster classification is used instead of the hazard maps, however an area in which an abnormality is detected using data from a satellite may be set as the target area. A method of detecting an abnormality from satellite data may be, for example, a method of comparing data from before a disaster with current data to confirm flooding or a building collapse from a data difference on a time axis. The detailed disaster information may be acquired by performing image analysis on all or some (conditions may be further narrowed down by area, time, or the like) images among the images and satellite data acquired in a target information area.

The target area may be configured in such a way as to be specified based on an area in which a communication environment has suddenly deteriorated, instead of the disaster information. This is because in this case, it is considered that in an area in which a communication environment has suddenly deteriorated, it is likely that some problem has occurred due to a disaster. A sudden deterioration of the communication environment is detectable when, for example, a difference between a communication volume before the deterioration of a communication environment and the current communication volume exceeds a predetermined threshold.

Instead of the disaster information, in case where a significant degree of acceleration in a vertical direction has been simultaneously detected from sensors (not illustrated) in the imaging units 21 of the plurality of vehicles 50, when an earthquake has occurred in an area near to where each of the plurality of vehicles is located, the area may be specified as the target area.

Next, an effect of the second example embodiment will be described.

According to the second example embodiment, the occurrence of data communication congestion during a disaster is suppressed and information necessary for responding to a disaster in a disaster-stricken area can be acquired. The reason is due to the following. The area specifying unit 33 of the communication volume control device 30 acquires disaster information indicating an area in which a disaster has occurred. This is because the transmission instruction unit 34 instructs the imaging devices of the vehicles outside the target area to reduce the communication volume to less than before the disaster occurred when transmitting the monitoring information to the monitoring device from the imaging devices, with the area in which the disaster has occurred set as the target area based on the acquired disaster information.

### Third Example Embodiment

A third example embodiment will be described.

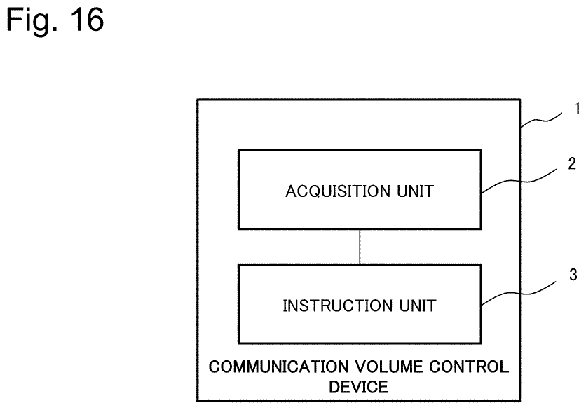

FIG. 16 is a block diagram illustrating an example of a configuration of the communication volume control device 1 according to the third example embodiment.

The communication volume control device 1 includes an acquisition unit 2 and an instruction unit 3. When a disaster occurs, the acquisition unit 2 acquires the target area information indicating a target area expected to be impacted by the disaster that has occurred. The instruction unit 3 instructs the plurality of imaging devices, which are mounted to each of a plurality of moving bodies and which transmit monitoring information related to captured images to the monitoring device at a predetermined timing, to adjust the communication volume based on the target area information when transmitting the monitoring information to the monitoring device from the imaging devices.

The acquisition unit 2 corresponds to the area specifying unit 33 according to the first example embodiment and the second example embodiment. The instruction unit 3 corresponds to the transmission instruction unit 34 according to the first example embodiment and the second example embodiment.

According to the third example embodiment, the occurrence of data communication congestion during a disaster is suppressed and information necessary for responding to a disaster in a disaster-stricken area can be acquired. The reason is due to the following. When a disaster occurs, the acquisition unit 2 of the communication volume control device 1 acquires the target area information indicating the target area expected to be impacted by the disaster that has occurred. This is because the instruction unit 3 instructs the imaging devices to adjust the communication volume when transmitting the monitoring information to the monitoring device from the imaging devices based on the target area information.

(Hardware Configuration)

In each of the above-described example embodiments, each constituent element of each device (the imaging devices 20, the communication volume control device 30, the monitoring device 40, and the like) indicate a functional unit block. Some or all of the each component of the each device may be enabled by any combination of a computer 500 and a program.

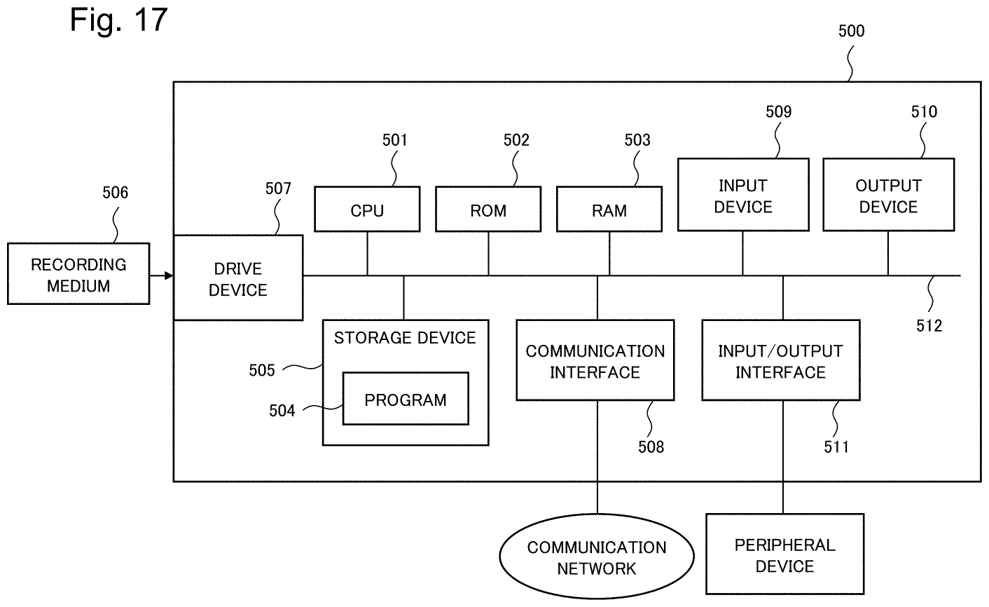

FIG. 17 is a block diagram illustrating an example of a hardware configuration of the computer 500. In reference to FIG. 17, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes instructions for enabling each function of the each device. The program 504 is loaded in advance in the ROM 502, the RAM 503, or the storage device 505. The CPU 501 enables the each function of the each device by executing the instructions included in the program 504. For example, the CPU 501 of the communication volume control device 30 executes the instructions included in the program 504 to enable functions of the disaster classification acquisition unit 32, the area specifying unit 33, and the transmission instruction unit 34. For example, the RAM 503 of the communication volume control device 30 may store data of the storage unit 31.

The drive device 507 performs reading and writing of a recording medium 506. The communication interface 508 provides an interface with a communication network. The input device 509 is, for example, a mouse, a keyboard, or the like, and receives information input from an operator or the like. The output device 510 is, for example, a display, and outputs (displays) information to the operator or the like. The input/output interface 511 provides an interface with peripheral devices. The bus 512 connects each constituent element of the pieces of hardware. The program 504 may be provided to the CPU 501 via a communication network, or may be loaded in advance to the recording medium 506 to be read by the drive device 507 and provided to the CPU 501.

The hardware configuration illustrated in FIG. 17 is an example, and constituent elements other than these may be added, or some constituent elements may be excluded.

There are various modification examples for methods of enabling the each device. For example, the each device may be enabled by any combination of computers and programs each differing for the each constituent element. A plurality of constituent elements included in the each device may be enabled by any combination of one computer and programs.

A part or all of the each constituent element of the each device may be enabled by a general-purpose or dedicated circuitry, which includes a processor and the like, or a combination thereof. The circuitry may be configured by a single chip, or it may be configured by a plurality of chips connected via a bus. A part or all of the each constituent element of the each device may be enabled by a combination of the above-described circuitry or the like and programs.

When a part or all of the each constituent element of the each device is enabled by a plurality of computers, circuitry, and the like, the plurality of computers, circuitry, and the like may be concentratedly arranged or dispersedly arranged.

The communication volume control device 30 may be arranged in the vehicles 50, or it may be arranged in a different place to the vehicles 50 and connected to the imaging devices 20 via a communication network.

Although the present disclosure has been described with reference to the example embodiments, the present disclosure is not limited to the example embodiments. Various modifications capable of being understood by those skilled in the art can be made to the configuration and the details of the present disclosure within the scope of the present disclosure. The configurations in each of the example embodiments can be combined with one another in so far as they do not depart from the scope of the present disclosure.

Some or all of the above-described example embodiments may be described such as in the following supplementary notes, however they are not limited to the following.

(Supplementary Note 1)

A communication volume control device including:

an acquisition means configured to acquire, when a disaster occurs, target area information indicating a target area expected to be impacted by the disaster that has occurred; and

an instruction means configured to instruct a plurality of imaging devices, which are mounted to each of a plurality of moving bodies and which transmit monitoring information related to captured images to a monitoring device at a predetermined timing, to adjust a communication volume based on the target area information when transmitting the monitoring information to the monitoring device from the imaging devices.

(Supplementary Note 2)

The communication volume control device according to Supplementary Note 1, wherein the target area information includes information indicating a degree of impact of the disaster for each area, and

the instruction means is configured to instruct the imaging devices of the moving bodies, which pass through areas in which a degree of impact of the disaster is smaller for each area, to reduce the communication volume to less than before the disaster occurred when transmitting the monitoring information to the monitoring device from the imaging devices.

(Supplementary Note 3)

The communication volume control device according to Supplementary Note 1 or 2, wherein the target area information is information to be specified from a hazard map indicating areas in which damage from the disaster is expected for each disaster classification, and

the instruction means instructs the imaging devices of the moving bodies outside a target area to reduce the communication volume by setting the areas in which damage from the disaster is expected and which are indicated by the hazard map associated with the classification of the disaster that has occurred as the target area.

(Supplementary Note 4)

The communication volume control device according to any one of Supplementary Notes 1 to 3, wherein the hazard map indicates areas in which damage from the disaster is expected and an expected level of damage in the areas, and

the instruction means instructs the imaging devices of the moving bodies outside an area in which the expected level of damage in respect of the disaster that has occurred in the hazard map is equal to or more than a predetermined value to reduce the communication volume.

(Supplementary Note 5)

The communication volume control device according to Supplementary Note 1 or 2, wherein the target area information is information to be specified from disaster information generated when a disaster occurs and which indicates an area in which the disaster has occurred, and

the instruction means instructs the imaging devices of the moving bodies outside the target area to reduce the communication volume by setting the areas in which the disaster has occurred indicated by the disaster information acquired in respect of the disaster that has occurred set as the target area.

(Supplementary Note 6)

The communication volume control device according to Supplementary Note 5, wherein the disaster information indicates areas in which damage has occurred and a level of damage in the areas, and

the instruction means instructs the imaging devices of the moving bodies outside an area in which the level of damage that has occurred is equal to or more than a predetermined value in the disaster information to reduce the communication volume.

(Supplementary Note 7)

The communication volume control device according to any one of Supplementary Notes 1 to 6, wherein the monitoring information includes images and an image capturing position of the images, and

when instructed to reduce the communication volume, the imaging devices exclude the images from the monitoring information when transmitting to the monitoring device.

(Supplementary Note 8)

The communication volume control device according to Supplementary Note 7, wherein the monitoring device displays a map indicating the image capturing position included in the monitoring information received from the imaging devices in different modes for when the monitoring information includes the images and when the monitoring information does not include the images.

(Supplementary Note 9)

The communication volume control device according to Supplementary Note 7, wherein the monitoring device displays images related to the monitoring information received from the imaging devices when the images are included in the monitoring information including a specified imaging capturing position, and when there is a request to display the images when images are not included, makes a request to the imaging devices, which are a transmission source of the monitoring information including the image capturing position, and displays the images received from the imaging devices in response to the request.

(Supplementary Note 10)

A communication volume control method including:

acquiring, when a disaster occurs, target area information indicating a target area expected to be impacted by the disaster that has occurred; and

instructing a plurality of imaging devices, which are mounted to each of a plurality of moving bodies and which transmit monitoring information related to captured images to a monitoring device at a predetermined timing, to adjust a communication volume based on the target area information when transmitting the monitoring information to the monitoring device from the imaging devices.

(Supplementary Note 11)

A recording medium with a program recorded therein, wherein the program is caused to execute a process including:

acquiring, when a disaster occurs, target area information indicating a target area expected to be impacted by the disaster that has occurred; and

instructing a plurality of imaging devices, which are mounted to each of a plurality of moving bodies and which transmit monitoring information related to captured images to a monitoring device at a predetermined timing, to adjust a communication volume based on the target area information when transmitting the monitoring information to the monitoring device from the imaging devices.

### REFERENCE SIGNS LIST

1, 30 Communication volume control devices
2 Acquisition unit
3 Instruction unit
10 Monitoring system
20 Imaging devices
21 Imaging unit
22 Time acquisition unit
23 Position acquisition unit
24, 31, 41 Storage units
32 Disaster classification acquisition unit
33 Area specifying unit
34 Transmission instruction unit
40 Monitoring device
42 Display control unit
50 Vehicles
500 Computer
501 CPU
502 ROM
503 RAM
504 Program
505 Storage device
506 Recording medium
507 Drive device
508 Communication interface
509 Input device
510 Output device
511 Input/output interface
512 Bus

What is claimed is:

1. A communication volume control device comprising:
at least one memory configured to store instructions; and
at least one processor configured to execute the instructions to:
acquire, when a disaster occurs, target area information indicating a target area expected to be impacted by the disaster that has occurred; and
instruct a plurality of imaging devices, which are mounted to each of a plurality of moving bodies and which transmit monitoring information related to captured images to a monitoring device at a predetermined timing, to adjust a communication volume based on the target area information when transmitting the monitoring information to the monitoring device from the imaging devices.

2. The communication volume control device according to claim 1, wherein
the target area information includes information indicating a degree of impact of the disaster for each area, and
wherein the at least one processor is further configured to execute the instructions to:
instruct the imaging devices of the moving bodies, which pass through areas in which a degree of impact of the disaster is smaller for each area, to reduce the communication volume to less than before the disaster occurred when transmitting the monitoring information to the monitoring device from the imaging devices.

3. The communication volume control device according to claim 1, wherein
the target area information is information to be specified from a hazard map indicating areas in which damage from the disaster is expected for each disaster classification, and
wherein the at least one processor is further configured to execute the instructions to:
instruct the imaging devices of the moving bodies outside a target area to reduce the communication volume by setting the areas in which damage from the disaster is expected and which are indicated by the hazard map associated with the classification of the disaster that has occurred as the target area.

4. The communication volume control device according to claim 3, wherein
the hazard map indicates areas in which damage from the disaster is expected and an expected level of damage in the areas, and
wherein the at least one processor is further configured to execute the instructions to:
instruct the imaging devices of the moving bodies outside an area in which the expected level of damage in respect of the disaster that has occurred in the hazard map is equal to or more than a predetermined value to reduce the communication volume.

5. The communication volume control device according to claim 1, wherein
the target area information is information to be specified from disaster information generated when a disaster occurs and which indicates an area in which the disaster has occurred, and
wherein the at least one processor is further configured to execute the instructions to:
instruct the imaging devices of the moving bodies outside the target area to reduce the communication volume by setting the areas in which the disaster has occurred indicated by the disaster information acquired in respect of the disaster that has occurred set as the target area.

6. The communication volume control device according to claim 5, wherein
the disaster information indicates areas in which damage has occurred and a level of damage in the areas, and
wherein the at least one processor is further configured to execute the instructions to:
instruct the imaging devices of the moving bodies outside an area in which the level of damage that has occurred is equal to or more than a predetermined value in the disaster information to reduce the communication volume.

7. The communication volume control device according to claim 1, wherein
the monitoring information includes images and an image capturing position of the images, and
when instructed to reduce the communication volume, the imaging devices exclude the images from the monitoring information when transmitting to the monitoring device.

8. The communication volume control device according to claim 7, wherein
the monitoring device displays a map indicating the image capturing position included in the monitoring information received from the imaging devices in different modes for when the monitoring information includes the images and when the monitoring information does not include the images.

9. The communication volume control device according to claim 7, wherein
the monitoring device displays images related to the monitoring information received from the imaging devices when the images are included in the monitoring information including a specified imaging capturing position, and when there is a request to display the images when images are not included, makes a request to the imaging devices, which are a transmission source of the monitoring information including the image capturing position, and displays the images received from the imaging devices in response to the request.

10. A communication volume control method comprising:
acquiring, when a disaster occurs, target area information indicating a target area expected to be impacted by the disaster that has occurred; and
instructing a plurality of imaging devices, which are mounted to each of a plurality of moving bodies and which transmit monitoring information related to captured images to a monitoring device at a predetermined timing, to adjust a communication volume based on the target area information when transmitting the monitoring information to the monitoring device from the imaging devices.

11. A non-transitory recording medium with a program recorded therein, wherein
the program is caused to execute a process including:
acquiring, when a disaster occurs, target area information indicating a target area expected to be impacted by the disaster that has occurred; and
instructing a plurality of imaging devices, which are mounted to each of a plurality of moving bodies and which transmit monitoring information related to captured images to a monitoring device at a predetermined timing, to adjust a communication volume based on the target area information when transmitting the monitoring information to the monitoring device from the imaging devices.
